(19) United States
(12) Patent Application Publication
(10) Pub. No.: US 2010/0023916 A1
(43) Pub. Date: Jan. 28, 2010

(54) Model Based Hint Generation For Lithographic Friendly Design

(76) Inventors: Marko P. Chew, Palo Alto, CA (US); Yue Yang, Cupertino, CA (US); Juan Andres Torres Robles, Wilsonville, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/416,077

(22) Filed: Mar. 31, 2009

Related U.S. Application Data
(63) Continuation-in-part of application No. 12/184,089, filed on Jul. 31, 2008.
(60) Provisional application No. 60/962,814, filed on Jul. 31, 2007.
(60) Provisional application No. 61/040,873, filed on Mar. 31, 2008.

(51) Int. Cl. G06F 17/50

(52) U.S. Cl. 716/19

(57) ABSTRACT

In various implementations of the invention, a model of an optical proximity correction process is employed to determine potential adjustments to a layout design for a mask that might resolve potential errors an image resulting from application of the mask in an optical lithographic process. In various implementations of the invention, corrected mask shapes, such as for example optical proximity corrected mask shapes, and associated printed image contours are generated through use of a model. Subsequently, the associated printed image contour and a desired printed image contour may be used to determine various edge segment adjustments to the corrected mask shapes that would realize the desired printed image contour. In various implementations of the present invention, the model for generation of the corrected mask shapes and the associated printed image contour is a square kernel model. With various implementations of the invention, the kernel represents a grey scale map wherein each pixel of the map is generated based on the desired displacement relative to the displacement to be modeled. For example by application of linear regression techniques. As a result, printed image contours and corrected mask shapes may be generated based upon an input layout design, wherein potential adjustments to the mask may be determined based upon a desired printed image contour.

### RELATED APPLICATIONS

This application claims priority under 35 U.S.C. §119 to and is a continuation of U.S. patent application Ser. No. 12/184,089, entitled “Model Based Microdevice Design Layout Correction,” filed on Jul. 31, 2008, and naming Marko Chew et al. as inventors, which application claims priority to U.S. Provisional Patent Application No. 60/962,814 entitled “FPOPC-Based Hint Generation for LFD Integration to P&R,” filed on Jul. 31, 2007, and naming Marco Chew et al. as inventors. This application further claims priority to U.S. Provisional Patent Application No. 61/040,873, entitled “Square Kernel Lithographic Friendly Design Models,” filed on Mar. 31, 2008 and naming Yuri Granik et al. as inventors. The above referenced applications are all incorporated entirely herein by reference.

### FIELD OF THE INVENTION

The invention relates to the field of integrated circuit design and manufacturing. More particularly, various implementations of the invention are applicable to lithographic friendly design, as well as to preparing a generating a mask corresponding to a layout design and for preparing the mask for employment in a manufacturing process.

### BACKGROUND OF THE INVENTION

Electronic circuits, such as integrated microcircuits, are used in a variety of products, from automobiles to microwaves to personal computers. Designing and fabricating microcircuit devices typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design. These various microcircuits are often referred to as integrated circuits (IC's).

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are then analyzed, to confirm that the circuit described by the device design will correctly perform the desired functions. This analysis is sometimes referred to as “formal verification.” Additionally, preliminary timing estimates for portions of the circuit are often made at this stage, using an assumed characteristic speed for each device, and incorporated into the verification process.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. Typically, a designer will select groups of geometric elements representing circuit device components (e.g., contacts, channels, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

IC layout descriptions can be provided in many different formats. The Graphic Data System II (GDSII) format is a popular format for transferring and archiving two-dimensional graphical IC layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in IC layout designs that are employed to manufacture integrated circuits. Once the microcircuit device design is finalized, the layout portion of the design can be used by fabrication tools to manufacturer the device using a photolithographic process.

There are many different fabrication processes for manufacturing a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in layout design data define the relative locations or areas of the circuit device that will be exposed to radiation through the mask. A mask or reticle writing tool is used to create the mask based upon the layout design data, after which the mask can be used in a photolithographic process. The image created in the mask is often referred to as the intended or target image, while the image created on the substrate, by employing the mask in the photolithographic process is referred to as the printed image.

As designers and manufacturers continue to increase the number of circuit components in a given area and/or shrink the size of circuit components, the shapes reproduced on the substrate become smaller and are placed closer together. This reduction in feature size increases the difficulty of faithfully reproducing the image intended by the layout design onto the substrate. As a result, manufacturing yields have declined compared to for example the 0.35 μm or the 0.25 μm process technology nodes. Additionally, manufacturing yields are difficult to stabilize even after manufacturing processes have been refined.

A principal reason for declining yields is that as feature sizes shrink, the dominant cause of defects change. At larger process technologies, yield limitation is dominated by random defects. Despite the best clean room efforts, particles still find a way to land on chips or masks, causing shorts or opens. In smaller process technologies, for example the nanometer process technology, the dominant source of yield loss is pattern-dependent effects. These defects are a result of the design's features being smaller than the wavelength of light. As a result, the physical effects of light at these smaller feature sizes must be accounted for.

Various common techniques exist for mitigating these effects. For example, optical process correction (OPC), phase shift masks (PSM) or other resolution enhancement techniques (RET) are commonly employed to prepare a physical layout designs for manufacturing. Additionally, physical verification techniques that assist in accounting for issues such as planerization and antenna effects are also employed on physical layout designs. Although these extensive modifications to the physical layout design resulted in a layout design that was unrecognizable by the designer, the resulting manufactured circuit matched the designer's intent.

However, application of these techniques requires the optical lithographic process to be simulated. This simulation is often accomplished by modeling the optical lithographic process. Generation of an optical model first requires that various designs be manufactured by the optical process to be modeled. Subsequently, measurements are taken of the manufactured design and models may be generated based upon the measurements of the actual manufactured design and the intended design. As indicated above, designs and the optical lithographic processes used to manufacture the designs are increasing in complexity. Accordingly, generation of optical models as well as application of resolution enhancement techniques such as optical proximity correction is increasingly burdensome.

### SUMMARY OF THE INVENTION

In various implementations of the invention, a model of an optical proximity correction process is employed to determine potential adjustments to a layout design for a mask that might resolve potential errors an image resulting from application of the mask in an optical lithographic process. In various implementations of the invention, corrected mask shapes, such as for example optical proximity corrected mask shapes, and associated printed image contours are generated through use of a model. Subsequently, the associated printed image contour and a desired printed image contour may be used to determine various edge segment adjustments to the corrected mask shapes that would realize the desired printed image contour. In various implementations of the present invention, the model for generation of the corrected mask shapes and the associated printed image contour is a square kernel model. With various implementations of the invention, the kernel represents a grey scale map wherein each pixel of the map is generated based on the desired displacement relative to the displacement to be modeled. For example by application of linear regression techniques. As a result, printed image contours and corrected mask shapes may be generated based upon an input layout design, wherein potential adjustments to the mask may be determined based upon a desired printed image contour.

These and additional aspects of the invention will be further understood from the following detailed disclosure of illustrative embodiments.

### BRIEF DESCRIPTION OF THE DRAWINGS

The present invention will be described by way of illustrative embodiments shown in the accompanying drawings in which like references denote similar elements, and in which:

FIG. 1 illustrates an illustrative computing environment;

FIG. 2 illustrates a portion of the illustrative computing environment of FIG. 1, shown in further detail;

FIG. 3 illustrates a layout design feature;

FIG. 4 illustrates the layout design feature of FIG. 3, shown in Further detail;

FIG. 5 illustrates a portion of a target layout design feature and an associated simulated printed image;

FIG. 5A illustrates the target layout design feature portion and the associated simulated printed image of FIG. 3, shown in further detail;

FIG. 5B illustrates the layout design feature of FIG. 3, modified by an optical proximity correction process;

FIG. 5C illustrates the layout design feature of FIG. 5B, shown in further detail;

FIG. 6 illustrates a lithographic friendly design flow;

FIG. 7 illustrates a model based hints design flow;

FIG. 8 illustrates a method of calibrating a model;

FIG. 9 illustrates a layout design;

FIG. 10 illustrates a method of determining aggressor shapes;

FIG. 11 illustrates a method of generating hints for model based design;

FIG. 12 illustrates a square kernel model;

Table 1 illustrates generated hints for an illustrative implementations; and

Table 2 illustrates generated hints for an illustrative implementation.

### DETAILED DESCRIPTION OF ILLUSTRATIVE IMPLEMENTATIONS

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Some of the methods described herein can be implemented by software stored on a computer readable storage medium, or executed on a computer. Additionally, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art are omitted.

### Illustrative Computing Environment

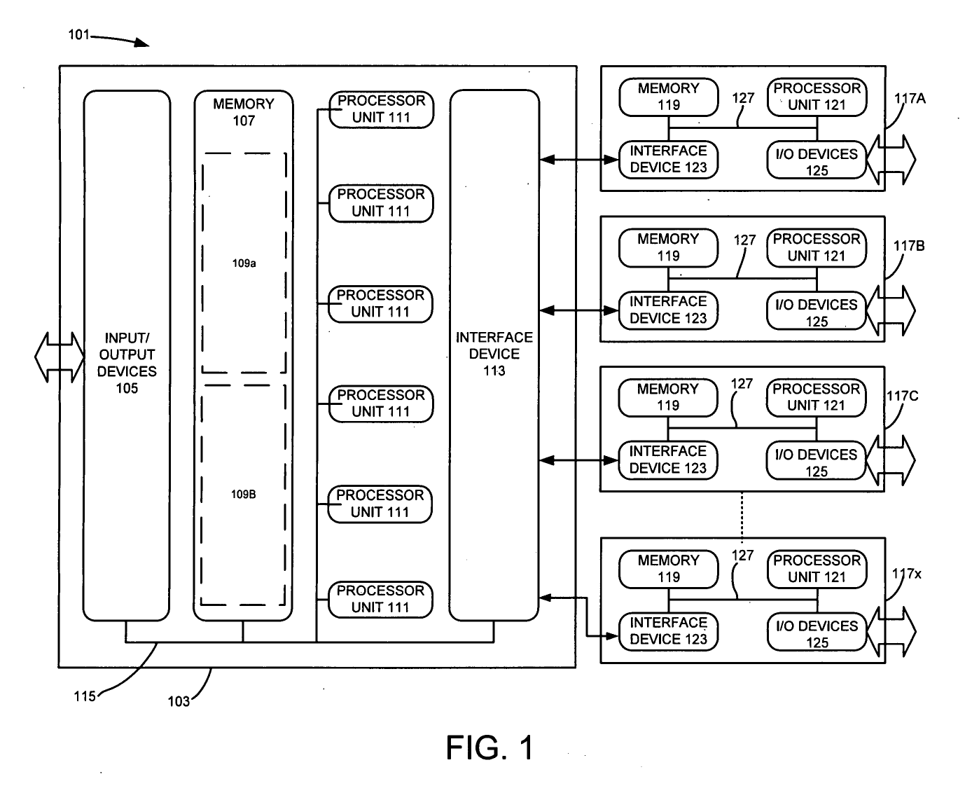

Various embodiments of the invention are implemented using computer executable software instructions executed by one or more programmable computing devices. Because these examples of the invention may be implemented using software instructions, the components and operation of a generic programmable computer system on which various embodiments of the invention may be employed is described. Further, because of the complexity of some electronic design automation processes and the large size of many circuit designs, various electronic design automation tools are configured to operate on a computing system capable of simultaneously running multiple processing threads. The components and operation of a computer network 101 having a host or master computer and one or more remote or slave computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom manufactured processor, such as a microprocessor designed to optimally perform specific types of mathematical operations. The interface device 113, the processor units 111, the memory 107 and the input/output devices 105 are connected together by a bus 115.

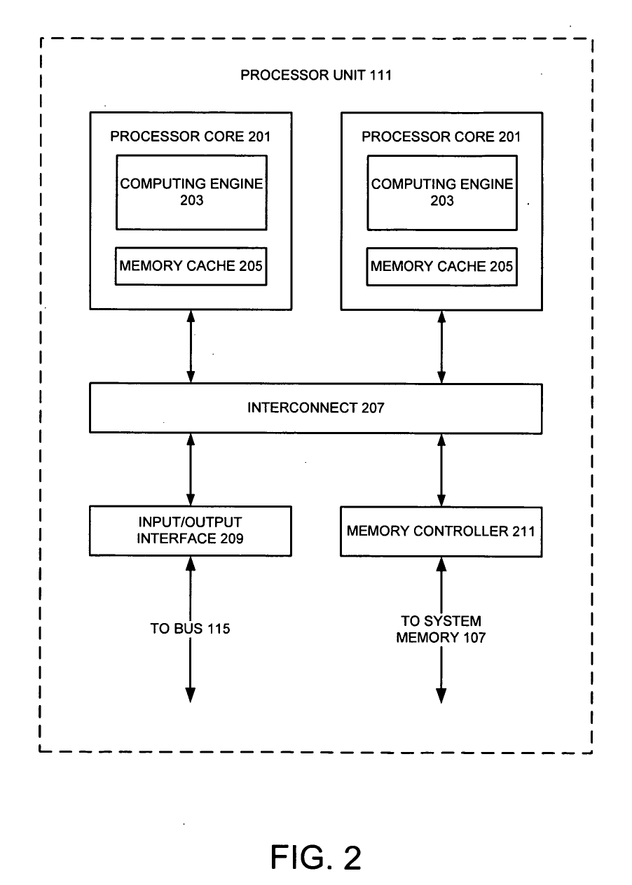

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell Broadband Engine™ (Cell) microprocessor created by Sony Corporation, Toshiba Corporation and IBM Corporation, the interconnect 207 may be implemented as an interconnect bus. With other processor cores 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 111 and the bus 115. Similarly, the memory controller 211 controls the exchange of information between the processor unit 111 and the system memory 107. With some implementations of the invention, the processor units 111 may include additional components, such as a high-level cache memory accessible shared by the processor cores 201.

While FIG. 2 shows one illustration of a processor unit 111 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 103 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units 111 each having three cores, a multi-core processor unit 111 with four cores together with two separate single-core processor units 111, or other desired configuration.

Returning now to FIG. 1, the interface device 113 allows the master computer 103 to communicate with the slave computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the slave computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 117 may include a memory 119, a processor unit 121, an interface device 123, and, optionally, one more input/output devices 125 connected together by a system bus 127. As with the master computer 103, the optional input/output devices 125 for the slave computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the slave computers 117 to communicate with the master computer 103 over the communication interface.

In the illustrated example, the master computer 103 is a multi-processor unit computer with multiple processor units 111, while each slave computer 117 has a single processor unit 121. It should be noted, however, that alternate implementations of the invention may employ a master computer having single processor unit 111. Further, one or more of the slave computers 117 may have multiple processor units 121, depending upon their intended use, as previously discussed. Also, while only a single interface device 113 or 123 is illustrated for both the master computer 103 and the slave computers 117, it should be noted that, with alternate embodiments of the invention, either the master computer 103, one or more of the slave computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 117 may alternately or additions be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only and is not intended to suggest any limitation as to the scope of use or functionality of alternate embodiments of the invention.

### Optical Proximity Correction

In a photolithographic process, as explained above, electromagnetic radiation is transmitted through selectively transparent areas of a mask. The radiation passing through these transparent areas then irradiates desired portions of a photoresistive material on a layer of semiconductor substrate. The mask in turn is created from layout design data describing the geometric features that should be manufactured on the semiconductor substrate, by way of the photolithographic process, in order to create the desired circuit. For example, if a transistor should have a rectangular gate region, then the layout design data will include a rectangle defining that gate region. This rectangle in the layout design data is then implemented in a mask for “printing” the rectangular gate region onto the substrate.

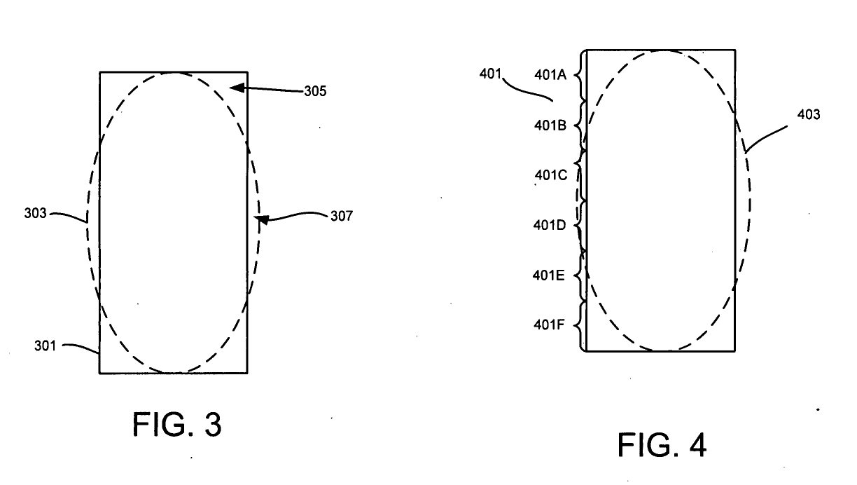

During a photolithographic process, however, optical effects will prevent the shapes defined by the mask from being faithfully imaged onto the substrate. Diffractive effects for example, may distort the image produced by a mask. Moreover, these distortions become more pronounced as the images produced by the mask become smaller relative to the wavelength of radiation used in the photolithographic process. Thus, a photolithographic process seeking to reproduce the target feature 301 illustrated in FIG. 3, may only produce the printed image 303. As seen in this figure, the printed image 303 is substantially narrower in the corners (e.g., corner 305) than the ideal rectangular shape intended by the target feature 301. Likewise, the printed image 303 may have areas (e.g., 307) that extend beyond the ideal rectangular shape intended by the target feature 301. The shape or feature intended to be printed during the optical lithographic process is often referred to as the target image or target shape. The image created by employing the mask in a photolithographic process, as described above, may be referred to as the printed image.

To correct for the optical distortions mentioned above, many circuit designers will attempt to modify the layout design data, producing modified mask features, to enhance the resolution of the images that will be produced by the modified mask during the photolithographic process. A resolution enhancement technique often employed by designers is called optical process correction (OPC) or optical proximity correction. Optical proximity correction is often applied to a layout design, in an effort to better control the amplitude and/or phase of the radiation transmitted by the mask at specific locations. In a typical optical proximity correction process, the edges of the geometric elements in the design are fragmented. For example, as shown in FIG. 4, an edge of the mask feature 401, which corresponds to the target feature 301 of FIG. 3 and may be used to create the printed image 403 of FIG. 4, has been fragmented into edge segments 401A-401F. The partitioning of edge segments within a given layout design depends upon the specific optical proximity correction process parameters, often referred to as the optical proximity correction “recipe.” The recipe specifies, among other factors, the size of the edge segments. Accordingly, not all edges within a layout design will be fragmented in every optical proximity correction process. Additionally, the size of the edge segments, such as the edge segments 401A-401F, resulting from fragmenting polygon edges within a layout design can vary depending upon the layout design, the optical proximity correction process, or the optical proximity correction process recipe.

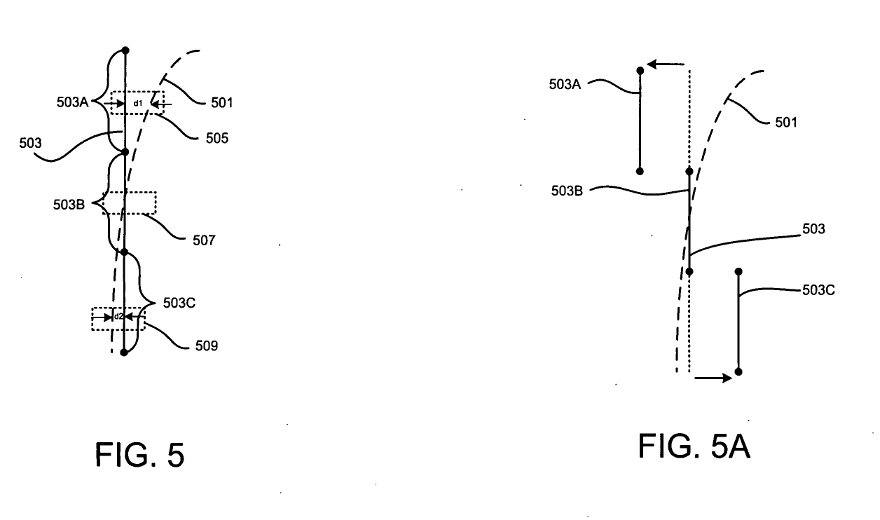

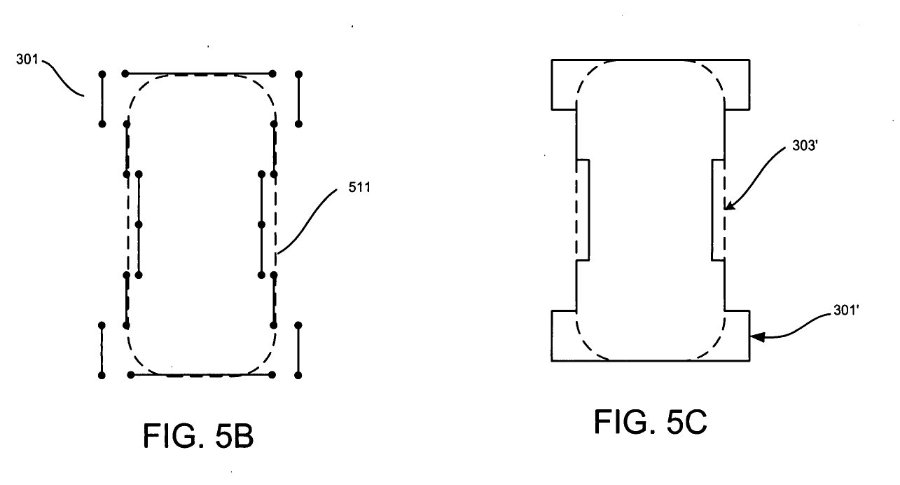

In attempting to correct for optical distortions within the photolithographic process, the optical proximity correction process simulates the printed image. That is, the photolithographic process is simulated in order to produce a simulated printed image. FIG. 5 illustrates a simulated printed image 501 and a mask feature 503. As can be seen in this figure, the mask feature 503 has been fragmented into edge segments 503A, 503B, and 503C. The simulated printed image 501 is compared to a target image, which corresponds to the mask feature 503 in this example. Typically, this comparison is done at each edge segment. For example, as shown in FIG. 5, the target image is a distance d1 away from the simulated printed image 501 at the edge segment 503A, the target image is a distance d2 away from the simulated printed image 501 at the edge segment 503C, while the target image intersects the simulated printed image 501 at the edge segment 503B. The distances between the target image and the simulated printed image 501 are often referred to as the edge placement error (EPE). Accordingly, in a typical optical proximity correction processes, each edge segment, as well as each unfragmented edge, will have an associated edge placement error. The location where the edge placement error is computed is often referred to as a simulation site. For example, FIG. 5A illustrates the simulation sites 505-509. In conventional optical proximity correction processes, the location of simulation sites does not change during the optical proximity correction process.

Following simulation and calculation of the edge placement error, the edge segments are individually moved in order to improve the resolution of the simulated printed image for the resulting mask. For example, as shown in FIG. 5A, the edge segment 503A is displaced in a direction away from the target image, in an effort to widen the corresponding portion of the image that would be produced by the resulting mask at the location of the edge segment 503A. Similarly, the edge segment 503C is displaced in a direction away from the target image, in an effort to narrow the corresponding portion of the image that would produced by the resulting mask at the location of the edge segment 503C. With various implementations of the invention, the displacement value will be a vector. More particularly, a displacement value will often contain a distance component and a direction component.

This process of simulating the image that would be produced using the mask feature, comparing the simulated image to the target image, and moving edge segments accordingly may be repeated a number of times. Each cycle of simulation, compare, and move is referred to as an iteration of the optical proximity correction process. With various implementations of the invention, a final simulation process is performed after the last iteration for purposes of reporting results to the user. For example, the final simulated printed image may be displayed to the user via a computer monitor. Alternatively, the value of the edge placement error at selected edge fragments may be provided to the user. In still alternative implementations, those edge fragments having an edge placement error greater than a threshold value may be provided to the user.

Typically, selecting edge segments to be moved during a given iteration, and the distance the edge segments are displaced, are determined based upon the edge placement errors for the edge fragment and the optical proximity correction process recipe. For example, an optical proximity correction process may move an edge segment some factor of the edge placement error for that edge fragment away from the simulated printed image or the target image. Additionally, each edge segment may be displaced the same distance during a given iteration. The specific parameters that control edge movement are dependent upon the tool used to implement the optical proximity correction process and the optical proximity correction process recipe.

Typically, the optical proximity correction process is allowed to iterate until the simulated image is sufficiently similar to the target image (e.g., both d1 and d2 are smaller than a threshold value), or until it is determined that the edge segments have converged on locations where no further movement of the edge segments will improve the simulated image. FIG. 5B shows the mask feature 401 of FIG. 4, with the edges fragmented and displaced, along with a simulated printed image 511. Once the final positions of the edge segments are determined in the layout design data as shown in FIG. 5B, a modified mask feature or corrected mask feature can be created from the adjusted layout design data. FIG. 5C shows a corrected mask feature 401′, produced from the displaced edge segments of FIG. 5B. Additionally, the printed image 403′ produced by the modified mask feature 401′ is shown. FIG. 5C illustrates that the corrected mask feature 401′ produces the printed image 403 that more closely correspond to the target image 301 of FIG. 3. The mask feature 401′ is often referred to as the optical proximity correction mask shape, while the printed image is often referred to as the image contour(s).

As optical proximity correction has been explained in detail above, the specifics of the various individual optical proximity correction processes disclosed herein are omitted from the balance of this disclosure. Instead general operations germane to an optical proximity correction process, for example, edge segment, displacement, iteration, convergence, or verification are used to describe the optical proximity correction operations implemented with various embodiments of the present invention. The abstract terms used to describe the optical proximity correction process are to be interpreted in light of the above description of optical proximity correction, the accompanying figures, and the knowledge possessed by those of ordinary skill in the art.

### Lithographic Friendly Design

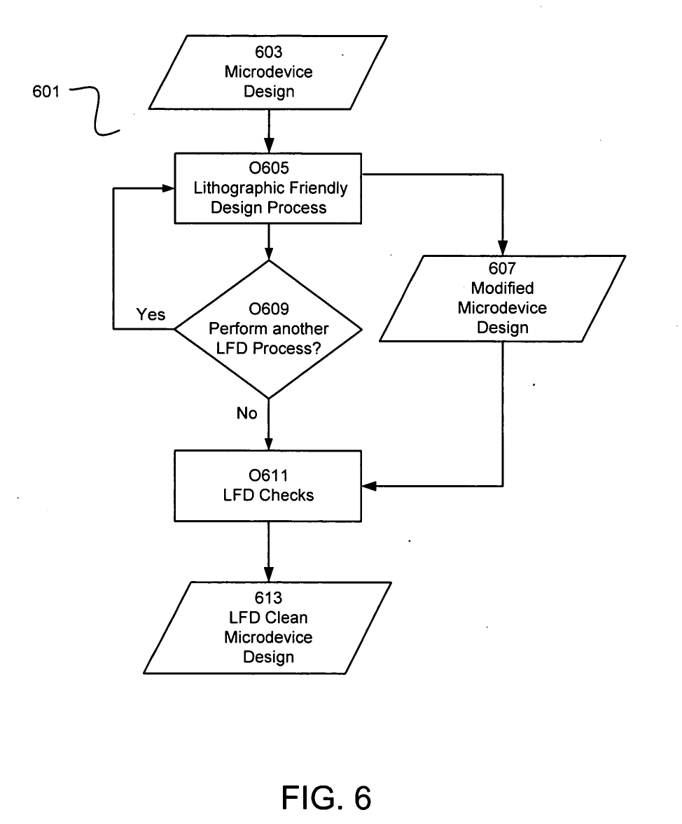

As discussed above, design layouts are typically adjusted prior to manufacturing in order to increase the fidelity of the optical lithographic process. However, as design complexity increase and design scale decreased, it is becoming increasingly necessary to account for these optical effects during the design stage of device development. Additionally, as illustrated above, performing optical proximity correction is expensive due to its iterative nature and the complexity of simulating the printed image. FIG. 6 illustrates a potential lithographic friendly design flow 601 that may be provided with various implementations of the present invention. As can be seen from FIG. 6, the flow 601 is implemented upon a microdevice design 603. The flow 601 includes an operation 605 for performing a lithographic friendly design process. As can be seen, the operation 605 may make adjustments to the microdevice design 603, resulting in a modified microdevice design 607. Additionally, as can be seen, the flow 601 includes an operation 609 for determining if the operation 605 should be repeated. In various implementations of the invention, during a subsequent iteration of the operation 605, a different lithographic friendly process is performed. For example, the first iteration of the operation 605 may cause a retargeting operation to be performed while the second iteration of the operation 605 may cause an optical proximity correction operation or a model based optical proximity correction approximation operations to be performed. Once the operation 609 determines that no further iterations of the operation 605 are to be performed, an operation 611 for performing a lithographic friendly design check on the modified microdevice design 607 may be performed. If the lithographic friendly design checks performed by the operation 611 all pass, the modified microdevice design may be certified or “determined” as being a lithographic friendly clean (LFD Clean) design.

### Lithographic Friendly Design Models

As discussed above, lithographic friendly design flows, such as the flow 601, include layout design modification steps, such as for example optical proximity correction. However, as explained above, performing optical proximity correction is computationally expensive. Accordingly, various design methodologies have been developed to generate corrected mask shapes and simulated printed image contours based upon a layout design. These various methodologies employ models of the optical lithographic process as well as the optical proximity correction process. This allows designers to perform design modifications earlier in the design process. Additionally, this enables designers to generate corrected mask shapes without having to perform a complete optical proximity correction process on the design. These methodologies are sometimes referred to as pseudo optical proximity correction.

A first type of methodology employs a modulation transfer function (MTF) model. Modulation transfer function models are used to give designers an early representation of a manufacturing process where only the optical conditions of the manufacturing process are known. This model is useful as it is available early in the design process and can be used to test potential manufacturing processes and aid designers in developing manufacturing processes. Additionally, modulation transfer function models are useful to identify areas of potential manufacturing errors for stable or known manufacturing processes. These models may also be used to indicate if the potential manufacturing error is a result of the layout design or the result of optical proximity correction.

A second type of methodology may be implemented with a drawn to contour (D2C) model. Drawn to contour models are typically used to represent a stable or known manufacturing process and will often include representations for any limitations in the optical proximity correction recipe. Various drawn to contour models are accurate to less than 5 nanometers, which enables designers to locate potential layout topology problems affecting connectivity such as pinching or bridging errors. Additionally, drawn to contour models are useful for locating parametric design problems such as high parasitic capacitances or extreme corner rounding of the optical proximity corrected contour.

An additional methodology is the fast pass optical proximity correction (FPOPC) method. Fast pass optical proximity correction is typically used as a first approximation of optical proximity correction. This methodology enable a corrected mask feature, such as the corrected mask feature 401′ of FIG. 5C, to be generated. One significant benefit of this is that areas of potential concern may be identified.

As it is desirable to have both the corrected mask features as well as the printed image contours to determine optimal layout adjustments and mask feature correction that will enable the intended printed image to be realized, a model capable of generating both types of features is needed. Various implementations of the present invention provide for generating either corrected mask features or printed image contours via a square kernel model. Square kernel models operate by mapping edge segment displacements from a reference optical proximity corrected layout to densities produced by the convolution of one or more two dimensional functions with the target layout. In various implementations of the invention, the edge segments displacement Δ is defined by a bias polynomial as shown in Equation (1) below, where αᵢ is a scalar constant (defined further later) and Dᵢ is the density for a given location (i) on the layout. Often each location (i) is referred to as a pixel.

$$Δ = {α}_{0} + {α}_{1} {D}_{1} + … + {α}_{m} {D}_{m} , where 0 = {\sum }_{i} {\sum }_{j \neq i} \vert {D}_{i} \cdot {D}_{j} \vert \qquad ( 1 )$$

As can be seen from Equation (1), the bias polynomial consists of a linear combination of densities produced by the convolution of a pre-defined orthogonal basis with the target layout.

### Lithographic Friendly Design Model Calibration

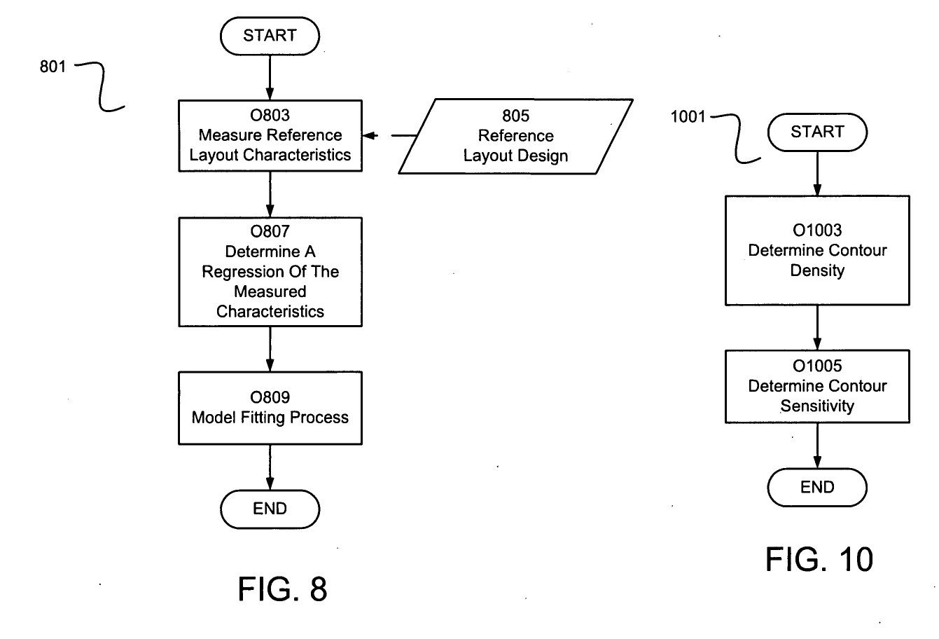

As indicated above, the models employed in optical proximity correction processes and pseudo optical proximity correction processes, such as the process 601, are often calibrated based upon a reference layout design. FIG. 8 illustrates a model calibration flow 801 that may be provided with various implementations of the invention. As can be seen from this figure, the model calibration flow 801 includes an operation 803 for measuring various characteristics of a reference layout design 805, an operation 807 for determining a regression of the measured characteristics, and an operation 809 for a performing model fitting process.

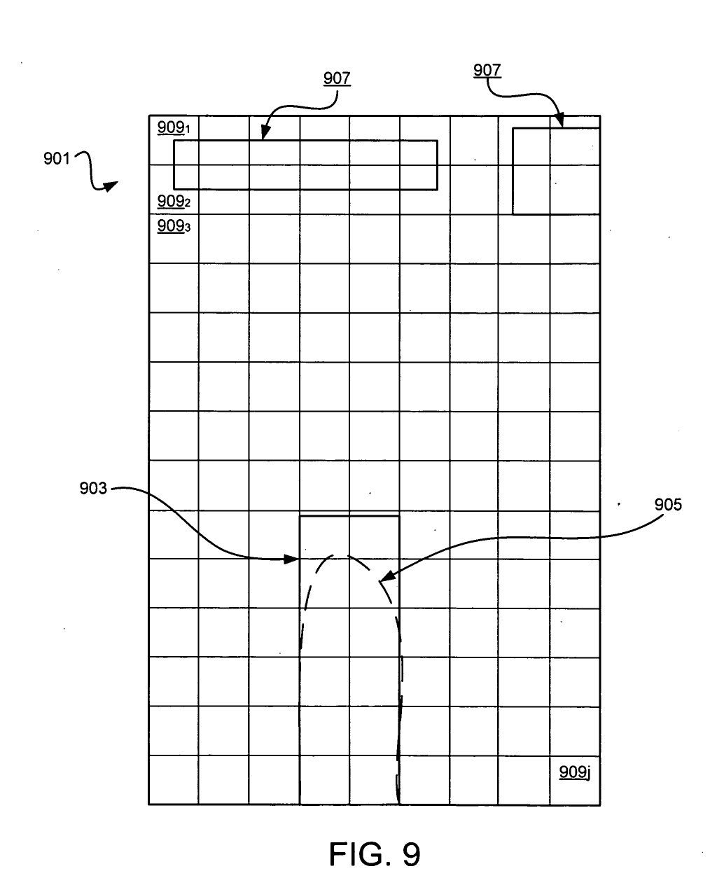

In various implementations of the invention, the measured characteristic is a density value. With various further implementations of the invention, the operation 803 may measure the density values by superimposing a grid over the identified potential print error. For example, FIG. 9 illustrates a layout design 901, including a target shape 903. As can be seen from this figure, the target shape 903 contains a potential print error 905. The layout design 901 further includes adjacent shapes 907, and density kernels 909 generated by superimposing a grid over the layout design. In various implementations of the invention, a density value is measured for each density kernel 909. With various implementations of the invention, the measured density value of a particular density kernel 909 is determined by measurement the difference between the edge of the target polygon 903 and the center of the corresponding density kernel 909. Those of skill in the art will appreciate that a vector of densities D, as shown in Equation (2), may be formed by the operation 803 of FIG. 8.

[d₀, d₁, d₂, . . . , dⱼ] (2)

With various implementations of the invention, the operation 803 measures a contour value as well as a density value. Still, in various implementations of the invention, the operation 803 approximates a contour using a Manhattan distance approximation. Further still, with various implementations of the invention, the operation 803 approximates a contour value using the contours orthogonal convexity. Additionally, Those of skill in the art will appreciate that a vector of contour coefficients, as shown by Equation (3), may be formed by the operation 803.

$$[ \begin{matrix}{c}_{0} \\ {c}_{1} \\ {c}_{2} \\ ⋮ \\ {c}_{j}\end{matrix} ] \qquad ( 3 )$$

In various implementations of the invention, the operation 807 employs a linear regression method for determining the regression of the measured values. For example, a single value decomposition (SVD) least squares method may be employed. Those of skill in the art will appreciate that many tools exists for performing regression analysis, and furthermore many tools exists for the single value decomposition least squares method of regression analysis.

Based upon values measured by the operation 803 and the regression determined by the operation 807, a model may be “fitted” to describe or represent the optical proximity correction process. More particularly, the operation 807 generates a model that describes the desired process, such as an optical proximity correction process. With various implementations of the invention, a Taylor series expansion model is generated by the operation 807. For example, Equation (4) illustrates a model in the form of a Taylor series expansion, which may be determined by the operation 807 of FIG. 8.

$$f = {c}_{0} + \sum {c}_{i} {d}_{i} + {\sum }_{i} {\sum }_{j = 1} {c}_{ij} {d}_{i} {d}_{j} \qquad ( 4 )$$

In various embodiments of the invention, a polynomial model is generated by the operation 807. For example, Equation (5) illustrates a model in the form of a polynomial that may be generated to describe an optical proximity correction process or alternatively an optical lithographic process.

$$f = {c}_{o} + {\sum }_{i = 1}^{j} {c}_{i} {d}^{i} \qquad ( 5 )$$

Still, with other implementations of the invention, a linear model is generated by the operation 807. For example, Equation (6) illustrates a model in linear form that may be generated to describe an optical proximity correction process or alternatively an optical lithographic process.

$$f = {c}_{o} + {\sum }_{i = 1}^{j} {c}_{i} {d}_{i} \qquad ( 6 )$$

Further still, in various implementations of the invention, a cross-term model may be generated by the operation 807. For example, Equation (7) illustrates a cross-term model that may be generated to describe an optical proximity correction process or alternatively an optical lithographic process.

f=c₀+Σcᵢdᵢ+ΣΣcᵢⱼdᵢdⱼ (7)

Those of skill in the art will appreciate that the size of the grid illustrated in FIG. 9 may vary with different implementations of the invention, or even within the same implementations of the invention. It should additionally be appreciated that the size of the grid may affect the accuracy of the model. However, in various implementations a kernel size of 5 to 25 microns may be used. With various implementations, a kernel size of 30 to 50 microns may be used.

As can be seen from Equation (1), by requiring the dot product of the densities to equal zero, we can solve for the polynomial and determine each pixels contribution to the total edge segment displacement

### Model Based Hint Generation

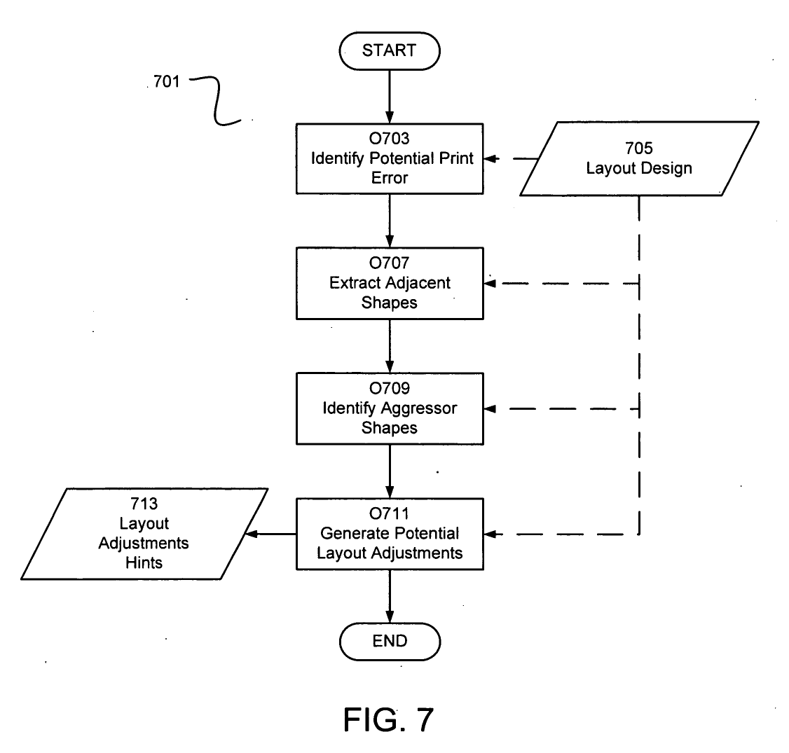

Various implementations of the invention provide a hint generation process that may be included into a microdevice design flow. For example, various implementations of the invention may be included into a lithographic friendly design flow, such as the flow 601 of FIG. 6. FIG. 7 illustrates a hint generation process 701 that may be provided according to various implementations of the invention. The hint generation process 701 includes an operation 703 for identifying a potential print error within a layout design 705. Additionally, the process 701 includes an operation 707 for extracting shapes adjacent to the identified potential print error from the layout design 705. With various implementations of the invention, the operation 707 for extracting shapes adjacent to the identified potential print error identifies entire polygons and associates the identified polygons as the shapes adjacent to the identified potential print error. In various implementations, the operation 707 identifies entire edges and associates the identified edges as the shapes adjacent to the identified potential print error. Still, in various implementations, the operation 707 identifies edge segments and associates the identified edge segments as the shapes adjacent to the potential print error.

As can be seen from FIG. 7, the process 701 further includes an operation 709 for identifying aggressor shapes from the extracted shapes. In various implementations of the invention, the operation 709 identifies those shapes adjacent to the potential print error that likely contribute to the potential print error. As discussed above, models are often employed to approximate post optical proximity correction shapes. In various implementations of the invention, the operation 709 employs a fast pass optical proximity correction model to identify those shapes having an effect upon identified potential print error. With various implementations of the invention, the operation 709 employs a modulation transfer function to identify those shapes having an effect upon the identified potential print error. Still, with various implementations of the invention, the operation 709 employs a drawn to contour model to identify those shapes having an effect upon the potential print error.

The process 701 further includes an operation 711 for generating a set of potential adjustments 713, which may be applied to the layout design 705 and might assists in resolving the identified potential print error. In various implementations of the invention, the set potential adjustments 713 is provided to a user via a user interface, such as an optical display. With various implementations of the invention, the set of potential adjustments 713 is saved to a memory storage location.

### Aggressor Shape Identification

Returning to FIG. 7, the process 701 includes the operation 709 for identifying aggressor shapes. In various implementations of the invention, a model, such as model described by Equations 4, 5, 6, or 7 may be employed to assist in identifying the shapes within the layout design 705 that have an affect upon the potential print error identified by the operation 703. FIG. 10 illustrates an aggressor shape identification flow 1001. In various implementations of the invention, the operation 709 of FIG. 7 performs the flow 1001 of FIG. 10. As can be seen from this figure, the aggressor identification flow 1001 includes an operation 1003 for determining an optical proximity corrected contour density and an operation 1005 for determining an optical proximity corrected contour sensitivity.

As indicated, the operation 1003 determines a contour density L. In various implementations of the invention, the contour density is the product of the density values and contour coefficients. For example, the operation 803 of FIG. 8 generates a matrix of densities and a matrix of contour coefficients, which may be used to form the contour density L as shown by Equation (8).

$$L = [ {d}_{0} {d}_{1} {d}_{2} … {d}_{j} ] [ \begin{matrix}{c}_{0} \\ {c}_{1} \\ {c}_{2} \\ ⋮ \\ {c}_{0}\end{matrix} ] \qquad ( 8 )$$

With various implementations of the invention, the operation 805 determines a rate of change of the contour density L with respect to the extracted shapes (eⱼ). For example, a rate of change the contour density measuring how the contour density changes with respect to the edges, as illustrated by Equation 9.

$$\frac{\partial l}{\partial {e}_{j}} \qquad ( 9 )$$

As described above, with some implementations, the edges are extracted and processed, while with other embodiments, the entire polygons are extracted and processed, still with other embodiments, the edge fragments are extracted and processed. Equation 9 illustrates measuring the gradient of the density measurements and contour approximations with respect to the extracted shapes.

Table 1 illustrates the results of an implementation of various embodiments of the present invention applied to an example microdevice design layout, with each row representing a different edge. Columns 1, 2, 3, and 4 identify the respective edge coordinates, column 5 identifies the gradient of the contour density with respect to the edge, and column six and column seven identify the direction and distance of a possible adjustment to the respective edges.

### Potential Layout Adjustment Generation

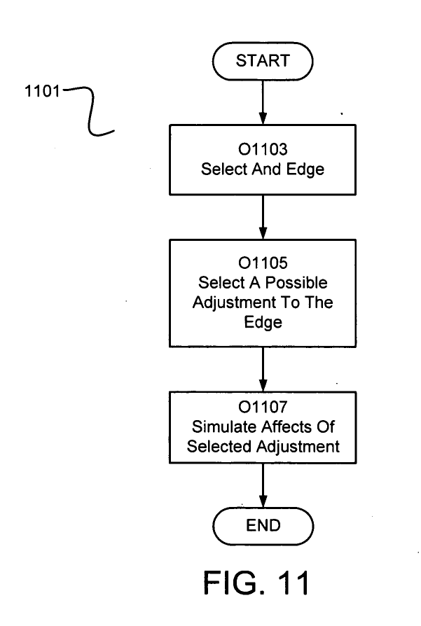

Referring back to FIG. 7, the process 701 includes an operation 711 for generating potential adjustments to the layout design. FIG. 11 illustrates a possible adjustment simulation flow 1101 that may be implemented according to various embodiments of the present invention. The possible adjustment simulation flow 1101 includes an operation 1103 for selecting an edge, an operation 1105 for selecting a possible adjustment to the edge, and an operation 1107 for simulating the affect of the possible adjustment to the edge.

In various implementations of the invention, the operation 1103 may select the edge with the largest gradient, as defined by for example Equation (9), first. With various implementations of the invention, operation 1103 selects an edge at random. Still, in other implementations of the invention, the edge is selected based upon location of the edge related to the potential print error. With various implementations of the invention, the operation 1105 selects a potential adjustment based upon the gradient, as defined by for example Equation (9). Still, with various implementation of the invention, the possible edge adjustment is selected based upon user input. Still, with other implementations, the possible edge adjustment is selected from a range. The range may be specified by the user or dictated by the underlying microdevice design layout technology and manufacturing process.

The operation 1107 employs the selected model to generate the affect of the potential adjustment selected by the operation 1105. With various implementations of the present invention, Equation is used to determine the affect of the potential adjustment.

Δ_{edge}=l(Δeⱼ) (10)

With various implementations of the invention, multiple edge movements are simulated. More particularly, possible adjustments for multiple edges are simulated. Alternatively, multiple possible adjustments for a single edge or multiple edges may be simulated.

In various implementations of the invention the possible adjustments are made to edge fragments. Still, with other implementations of the invention the possible adjustments are made to the entire polygon.

Additionally, with various implementations of the present invention, the possible adjustments are ranked and provided as “hints” to the user. The hints may be stored in vector format as illustrated in Tables 1 and 2, or the hints may be formatted into a structure suitable for viewing geometric results. For example, the Relational Database Format (RDB) usable by Calibre, available from Mentor Graphics Corporation of Wilsonville, Oreg.

### Square Kernel Model Based Hints

As stated above, square kernel models provide a means to generate corrected mask shapes as well as printed image contours. Accordingly, given the printed image contours, associated corrected mask shapes, and the intended printed image, square kernels may be employed in a hint based adjustment process, such as the process 701 if FIG. 7. As indicated above, a square kernel model, as represented by Equation (1) above, defines the displacement of edge segments in corrected mask shapes as well as printed image contours based upon densities of pixels in the layout design. Square kernels are directional. More particularly, the convolution of the densities is always aligned with the orientation of the edges, by looking into or out from the target edge.

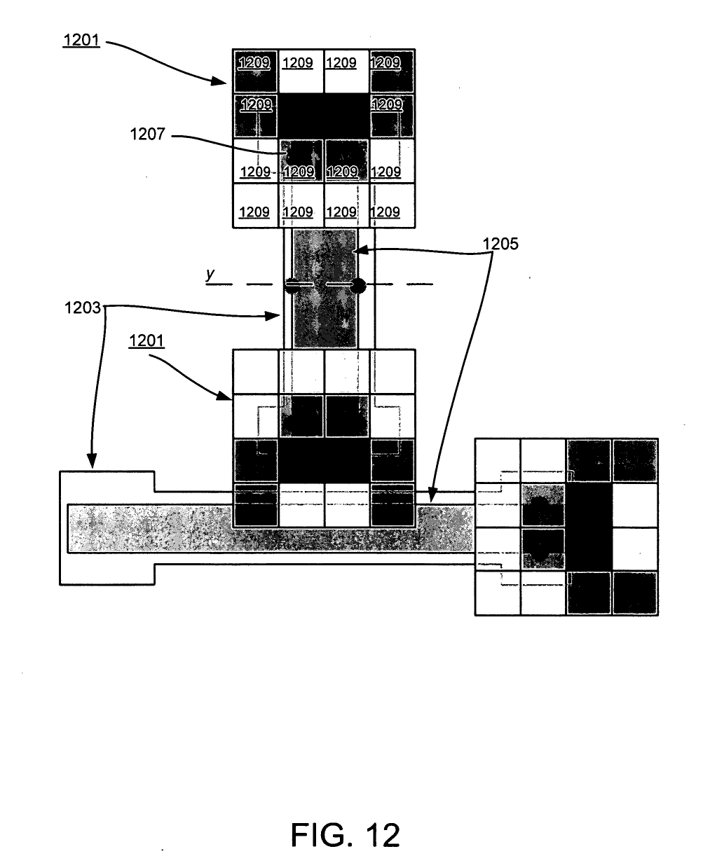

FIG. 12 illustrates a square kernel model. As can be seen from this figure, kernel components 1201 have been tiled and overlaid on top of a corrected mask shape 1203 and a printed image contour 1205. What is meant by tiled is that the square kernel model describes two dimensional features, i.e. corrected mask shapes and printed image contours. Accordingly, the square kernel is reproduced about the y axis of the density matrix. As FIG. 12 illustrates, the displacement A of an edge is the convolution of the scaled densities (i.e. Equation (1)). More particularly, each density kernel component 1201 describes a particular contribution to the displacement A of a given edge. The displacement Δ can be found by convolving the corresponding contributions of each density kernel component 1201. For example, the displacement of the edge 1207 would be the convolved densities of the pixels 1209.

Various implementations of the invention provide for determining a potential layout adjustment by solving Equation (1) for the densities, given a target.

### CONCLUSION

In various implementations of the invention, a model of an optical proximity correction process is employed to determine potential adjustments to a layout design for a mask that might resolve potential errors an image resulting from application of the mask in an optical lithographic process. In various implementations of the invention, corrected mask shapes, such as for example optical proximity corrected mask shapes, and associated printed image contours are generated through use of a model. Subsequently, the associated printed image contour and a desired printed image contour may be used to determine various edge segment adjustments to the corrected mask shapes that would realize the desired printed image contour. In various implementations of the present invention, the model for generation of the corrected mask shapes and the associated printed image contour is a square kernel model. With various implementations of the invention, the kernel represents a grey scale map wherein each pixel of the map is generated based on the desired displacement relative to the displacement to be modeled. For example by application of linear regression techniques. As a result, printed image contours and corrected mask shapes may be generated based upon an input layout design, wherein potential adjustments to the mask may be determined based upon a desired printed image contour.

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

TABLE 1

| | | | | | | |
|---|---|---|---|---|---|---|
| 13.615 | 16.395 | 13.615 | 17.595 | 0.0237 | 0 | 0.0676 |
| 13.415 | 16.395 | 13.415 | 17.110 | 0.0111 | 0 | 0.1446 |
| 14.015 | 16.295 | 14.015 | 17.995 | 0.0036 | 0 | 0.4475 |
| 13.815 | 16.395 | 13.815 | 17.795 | 0.0020 | 0 | 0.8153 |
| 13.615 | 17.595 | 13.515 | 17.595 | 0.0011 | 3 | 1.4408 |
| 13.515 | 17.815 | 13.515 | 18.335 | 0.0001 | 0 | 12.6474 |
| 13.415 | 17.795 | 13.215 | 17.795 | −0.0006 | 2 | 2.5876 |
| 13.815 | 17.795 | 13.715 | 17.795 | −0.0008 | 2 | 2.1016 |
| 13.215 | 17.795 | 13.215 | 17.995 | −0.0009 | 1 | 1.8240 |
| 13.615 | 17.815 | 13.515 | 17.815 | −0.0026 | 2 | 0.6264 |
| 13.415 | 17.615 | 13.415 | 17.795 | −0.0026 | 1 | 0.6230 |
| 13.115 | 17.615 | 13.415 | 17.615 | −0.0031 | 3 | 0.5161 |
| 13.415 | 17.110 | 13.315 | 17.11 | −0.0068 | 2 | 0.2347 |

TABLE 2

| | | | | | | |
|---|---|---|---|---|---|---|
| 13.615 | 17.595 | 13.515 | 17.595 | 0.0021 | 3 | 0.7658 |
| 13.815 | 17.795 | 13.715 | 17.795 | 0.0004 | 3 | 3.9939 |
| 13.415 | 17.795 | 13.215 | 17.795 | 0.0003 | 3 | 4.8937 |
| 13.215 | 17.795 | 13.215 | 17.995 | −0.0001 | 1 | 13.7094 |
| 14.015 | 16.295 | 14.015 | 17.995 | −0.0004 | 1 | 3.9599 |
| 13.515 | 17.815 | 13.515 | 18.335 | −0.0010 | 1 | 1.6547 |
| 13.115 | 17.615 | 13.415 | 17.615 | −0.0012 | 3 | 1.3379 |
| 13.415 | 17.110 | 13.315 | 17.110 | −0.0023 | 2 | 0.6821 |
| 13.415 | 17.615 | 13.415 | 17.795 | −0.0029 | 1 | 0.5526 |
| 13.615 | 17.815 | 13.515 | 17.815 | −0.0031 | 2 | 0.5207 |
| 13.415 | 16.395 | 13.415 | 17.110 | −0.0100 | 1 | 0.1607 |
| 13.815 | 16.395 | 13.815 | 17.795 | −0.0124 | 1 | 0.1287 |
| 13.615 | 16.395 | 13.615 | 17.595 | −0.0943 | 1 | 0.0170 |

What is claimed is:

1. A method of compiling a set of possible adjustments to a portion of a microdevice design layout, comprising:
accessing a portion of a layout design, the layout design containing a potential manufacturing fault;
extracting a plurality of shapes neighboring the potential manufacturing fault;
employing a process model to simulate a plurality of possible adjustments to the plurality of shapes; and
saving the plurality of possible adjustments to a memory storage location.
